(19) United States
(12) Patent Application Publication
(10) Pub. No.: US 2007/0195069 A1
(43) Pub. Date: Aug. 23, 2007

(54) Pen apparatus, system, and method of assembly

(75) Inventors: Robert G. Kable, Dublin, OH (US); Adam T. Kable, Powell, OH (US); Lawrence J. Heringer, Sunbury, OH (US); Brent B. Wilson, Plain City, OH (US)

Correspondence Address: MUELLER AND SMITH, LPA;MUELLER-SMITH BUILDING, 7700 RIVERS EDGE DRIVE, COLUMBUS, OH, 43235, US

(73) Assignee: Scriptel Corporation, Columbus, OH (US)

(21) Appl. No.: 11/598,500

(22) Filed: Nov. 13, 2006

Related U.S. Application Data
(63) Continuation-in-part of application No. 11/360,220, filed on Feb. 23, 2006.

(51) Int. Cl. G06F 3/033

(52) U.S. Cl. 345/179

(57) ABSTRACT

Pen apparatus, system and method of assembly wherein a pick-up rod assembly performs in conjunction with a normally closed switch to define a pen-up tip switch condition. Coordinate signal information is provided from the pick-up rod assembly to an amplification network carried by an elongate printed circuit board. A biased signal forming a component of the a.c. amplification network is additionally used in conjunction with a comparator and the noted normally closed switch to provide pen-up and pen-down orientation data to a host system.

### CROSS-REFERENCE TO RELATED APPLICATIONS

The present application is a continuation-in-part of application for U.S. patent Ser. No. 11/360,220, by Kable, et al., filed Feb. 23, 2006, entitled “Pen Apparatus and Method of Assembly”

### STATEMENT REGARDING FEDERALLY SPONSORED RESEARCH

Not applicable.

### BACKGROUND OF THE INVENTION

The history of technical development of electrographic devices is relatively short. At the present time, the operational quality of the now ubiquitous products is such that the terms “pen”, “paper”, “terminal” and “ink” are used in describing these computer driven interactive systems. Price and product reliability now have become significant factors in the electrographic market, the earlier significant challenges in technical development having been met.

Early approaches to digitizer structures looked to an arrangement wherein a grid formed of two spaced arrays of mutually, orthogonally disposed fine wires was embedded in an insulative carrier. One surface of this structure served to yieldably receive a stylus input, which yielding caused the grid components to intersect and readout coordinate signals. Later approaches to achieving readouts were accomplished through resort to a capacitive coupling of what was then termed a “stylus” or “locating instrument” with the position responsive surface to generate paired analog coordinate signals. Capacitive coupling was carried out either with a grid layer which is formed of spaced linear arrays of conductors or through resort to the use of an electrically resistive material layer or coating.

In the early 1980s, investigators recognized the promise of combining a digitizer surface with a visual readout. This called for a digitizer surface which was provided as a continuous resistive coating which was transparent. A variety of technical problems were encountered in the development of an effective resistive coating type digitizer technology, one of which was concerned with the non-uniform nature of the coordinate readouts received from the surface. Generally, precise one-to-one correspondence or linearity between the position of a stylus and the resultant coordinate signals was necessitated but posed an illusive goal. Because the resistive coatings could not be practically developed without local thickness variations, the non-linear aspects of the otherwise promising approach called for a substantial amount of research and development. A quite early investigation in this regard is described by Turner, in U.S. Pat. No. 3,699,439 entitled “Electrical Probe-Position Responsive Apparatus and Method”, issued Oct. 17, 1972. This approach used a direct current form of input to the resistive surface from a hand-held stylus, the tip of which was physically applied to the resistive surface. Schlosser, et al., in U.S. Pat. No. 4,456,787, entitled “Electrographic System and Method”, issued Jun. 26, 1984, described the development of an a.c. input signal in conjunction with such devices as well as the signal treatment of the resulting coordinate pair output. This transparent system applied excitation signals to a passive tablet. See additionally in this regard, Quayle, et al., U.S. Pat. No. 4,523,654. A voltage waveform zero-crossing approach was suggested by Turner to improve resolution in U.S. Pat. No. 4,055,726 entitled “Electrical Position Resulting by Zero-Crossing Delay”, issued Oct. 25, 1977. Kable, in U.S. Pat. No. 4,600,807 issued Jul. 15, 1986, described a signal treatment technique for transparent digitizer systems. In general, this approach utilized a plurality of switches along the four coordinate borders of the tablet structure. An a.c. drive signal was applied from one border, while the opposite border was retained at ground for a given coordinate readout, for example, in the x-axis direction. Plus and minus values were developed for generating x-coordinate pairs as well as y− coordinate pairs. During the evaluation process those switches aligned along the borders not being used as ground or as drivers were retained in a “floating” condition. Thus, the switching exhibited three states for a given coordinate generating operation. Such utilization of a third or floating state with the switches was the subject of some noise generation and the investigators looked to avoidance of the floating state as well as the relatively large requisite number of switches which were required.

Substantially improved accuracies for the resistive surface-type digitizing devices was achieved through a critically important correction procedure developed by Nakamura and Kable as described in U.S. Pat. No. 4,650,926, issued Mar. 17, 1987. With the correction procedure, memory retained correction data was employed with the digitizer such that any given pair of coordinate signals were corrected in accordance with data collected with respect to each digitizer resistor surface unit during its manufacture. With such an arrangement the speed of correction was made practical and the accuracy of the devices was significantly improved. In general, this correction procedure remains in the industry at the present time.

In order to avoid interference from externally generated noise, hand effects and the like, investigators determined that resistivities for transparent digitizers preferably should have fallen within predetermined acceptable ranges, for example, between 400 and 3,000 ohms per square. To achieve higher levels of resistivities as desired, very thin resistive coatings, for example, indium tin oxide (ITO) were employed. However, it was observed that over a period of time, surface effects would affect the resistivity value of a given tablet occasioning an unwanted “drift” of such value as to effect long term accuracy. To improve the long term stability of the coatings, thicker coatings have been employed in combination with discontinuities in the layer itself as was described by Kable, et al. in U.S. Pat. No. 4,665,283, issued May 12, 1987. Improvements in performance also were achieved through utilization of angular-shaped electrodes at corner positions as well as a conductive band or band of enhanced conductivity which was positioned intermediate the outer periphery of the digitizer device and the active area thereof as described by Nakamura and Kable, in U.S. Pat. No. 4,649,232, entitled “Electrographic Apparatus”, issued Mar. 10, 1987.

Improvements in the pick-up devices utilized with digitizers were evolved to enhance overall performance of the systems. For example, an improved tracer or cursor was described by Kable, et al., in U.S. Pat. No. 4,707,572, entitled “Tracer for Electrographic Surfaces”, issued Nov. 17, 1987. Similarly, Kable described an improved stylus (now pen) structure in U.S. Pat. No. 4,695,680, entitled “Stylus for Position Responsive Apparatus Having Electrographic Application”, issued Sep. 22, 1987. In 1988, Schlosser and Kable developed a transparent electrographic system and apparatus which achieved very important aspects of distortion control without undue loss of operational surface. This development lowered the number of solid-state switching components required about the border of the active surface and the three state approach was eliminated. The development permitted a broad range of practical applications of the resultant technology not only for utilization with digitizer tablets but also for such applications as electronic notepads and the like. That technology continues in production at the present time 14 years later, notwithstanding Moore's Law (Gordon Moore, Fairchild Semiconductor Corporation, 1964). See Schlosser and Kable, U.S. Pat. No. 4,853,493, issued Aug. 1, 1989.

For the most part, the pen and tablet or terminal systems currently perform by applying a.c. excitation to the corners of the tablet while the pen, connected to the system with a shielded cable asserts ground at its pen-down location to develop coordinate signals.

In application for U.S. patent Ser. No. 11/360,220 filed Feb. 23, 2006 entitled “Pen Apparatus and Method of Assembly” by Kable, et al., an improved electrographic pen is described exhibiting a highly responsive pen-down switching function. Further described is a unique use of bias voltage to generate a delay function which is activated as the pen is maneuvered from a pen-up to a pen-down operation to negate polluted, z-axis related coordinate data.

In addition to electrographic tablet and pen systems, industry also developed a touch technology where the user touches a defined region of a tablet as part of an interactive process. For many applications, pen-based and touch-based technologies have been combined. For example, credit card processing at retail point-of-sale stations perform in a touch mode to elect credit or debit processing and in a pen mode for customer signatures. Following the introduction of these bi-modal systems aberrations were found to occur when the grounded sheath-containing pen cables inadvertently touched the electrographic surface with which the pen was intended to be used. Where this occurred during a touch mode, false information was generated. To correct for such inadvertent anomalies, when the systems were in a touch mode, the shield of the pen cable was driven with the same a.c. signal as was used to excite the tablet. Thus in the event of the cable touching the tablet during the touch mode the differential capacitance between the cable shield and the graphic surface became zero to eliminate any adverse effect. Generally, the computer-based control system carried out the switching between touch and pen modes by sinking the a.c. shield drive signal at the cable sheath to ground.

Typically, the pen circuits and shield drive circuits have been configured with operational amplifiers. As efforts were undertaken to lower the cost of these systems, among other things, the ratings for such components were lowered and system coordinate data was becoming unreliable. With circuit components operating out of specification phenomena occurred such as the differential capacitance between cable and tablet being moved from a zero value to remove its transparency and evoke the registering of false touches.

### BRIEF SUMMARY OF THE INVENTION

The present discourse is addressed to pen apparatus for use with electrographic surfaces operating within a system having both pen and touch modes of performance. Designed to incorporate a minimum number of parts which are assembled with minimized procedural steps, the pens are fabricable at improved cost levels. Reliability of tip switching to provide pen-up and pen-down orientation data has been enhanced to the extent that cycle testing to failure for the quite simple design reaches several millions of cycles. Polycarbonate cartridge components are molded with switching cavities having buttressed wall components with forwardly disposed robust stop surfaces abuttably engageable with the travel limiting surface of a pick-up rod assembly. That assembly is mechanically forwardly biased by a spring engaging a mount portion which extends rearwardly of the switching cavity. The tip switching function is designed with a normally closed condition corresponding with a pen-up orientation. As a consequence, actuating the switch to an open condition is carried out by a very small pen-down axial movement of the pick-up rod assembly. The mechanical operation of the switch is essentially non-detectible by a user. Switching contact action is made highly reliable through the utilization of an electrically conductive conformal surface at a moveable contact member. In this regard, the surface is developed with a carbon-filled silicon insert. The a.c. pen coordinate position signals entering the pen apparatus through the pick-up rod assembly are amplified by an operational amplifier performing in conjunction with a bias. This amplifier, in effect, drives the cable leading to a host system. This amplifying single treatment network as well as pen orientation detector network are carried by an elongate printed circuit board assembly. Transmission of coordinate data from the pick-up rod assembly to the amplifying circuit is through a pen axis aligned electrically conductive helical spring which further provides the mechanical switch closing bias for the switching function. Transmission of tip switch conditions back to a pen orientation detection network is through a resilient stamped and thus inexpensive metal transition contact member which, during pen assembly is simply inserted within a cartridge enclosure component without a soldering or connection requirement.

The pen orientation detector network at the printed circuit board utilizes the amplification stage biasing feature by passing it through the normally closed tip switch function and thence into one input of an operational amplifier configured as a comparator. The opposite input to that comparator function again is the noted bias but reduced in value by one half. With the arrangement, the comparator functions to control a solid-state switch such as a field effect transistor to provide pen-up or pen-down information to the host system. The comparator and solid-state switch additionally perform in concert with a delay network which delays transmission of a pen-down signal to the host system for an interval long enough to eliminate transmission of z-axis or polluted pen position data.

Protection of the operational amplifier component of the signal treatment circuitry during a touch mode of operation wherein the shield of the cable is excited with an a.c. waveform emulating that as the electrographic surface is accomplished with a filter configured to filter the ground input to circuit supply power, an arrangement which effectively isolates the amplifying operational amplifier from deleterious signal imposition.

The method for making the pen apparatus comprises the steps:
(a) providing a generally cylindrical polymeric outer housing extending, along a pen axis, from a tip region having a mouth, to a cable support region;
(b) providing a pair of generally half cylindrical polymeric cartridge enclosure components which when abuttably mated to define a cartridge enclosure are slideably insertable within the outer housing in symmetrical disposition about the pen axis and define a forward region with a containment cavity, an intermediate region and rearward cable engagement region, the containment cavity having a rearward stop surface with a passage extending therethrough alignable with the pen axis;
(c) providing an elongate circuit board having oppositely disposed surfaces designated upper surface and lower surface extending between a forward end and a rearward end, the upper surface supporting a signal treatment network having an input junction at the forward end locatable at the, pen axis and an output extending to a terminal array adjacent the rearward end, the upper surface further supporting a pen orientation network having an input at an electrical contact pad generally adjacent the forward end at the lower surface locatable at the pen axis and having an output extending to the terminal array;
(d) providing a pick-up rod assembly extending from a tip to a mount portion and having a switching component located forwardly of the mount portion at a location for positioning at the containment cavity;
(e) providing a cable assembly with an array of leads corresponding with the terminal array;

(f) electrically coupling the cable assembly array of leads with the circuit board terminal array;
(g) providing an electrically conductive helical spring;
(h) coupling the helical spring to the circuit board supported signal treatment network input junction at the forward end in a manner wherein the spring extends forwardly for general alignability with the pen axis to a forward connection portion;
(i) coupling the pick-up rod assembly mount portion to the spring forward connection portion in a manner wherein the pick-up rod assembly extends forwardly for general alignability with the pen axis, the pick-up rod assembly, spring, circuit board and cable assembly defining a sub-assembly generally locatable about the pen axis;
(j) providing a transition contact member with a contact portion and an integrally formed resilient extension;
(k) inserting the transition contact member within one cartridge enclosure component in a manner wherein the contact portion is locatable within the containment cavity and the resilient extension is extensible through the stop surface passage to extend rearwardly;
(l) inserting the sub-assembly upon the one cartridge enclosure component;
(m) positioning the other cartridge component over the one cartridge component to define the cartridge enclosure;
(n) providing a generally cylindrical electrostatic shield assembly having a sleeve portion and a forwardly extensible necked-down portion;
(o) inserting the cartridge enclosure within the shield assembly sleeve portion;
(p) providing a polymeric pen tip;
(q) inserting the pen tip over the shield assembly necked-down portion in a manner internally engaging the pick-up rod assembly tip to define a pen interior;
(r) testing the pen interior; and
(s) when the pen interior passes the testing step, then inserting the pen interior into the outer housing.

Other objects of the disclosure will, in part, be obvious and will, in part, appear hereinafter.

The embodiments, accordingly, comprise the system, apparatus and method possessing the construction, combination of elements, arrangement of parts and steps which are exemplified in the following detailed disclosure.

For a fuller understanding of the nature and objects hereof, reference should be had to the following detailed description taken in connection with the accompanying drawings.

### BRIEF DESCRIPTION OF THE DRAWINGS

FIG. 1 is a schematic representation of a one-dimensional model of an electrographic apparatus of the type employing the pen apparatus of the invention;

FIG. 2 is a schematic equivalent circuit of the model of FIG. 1;

FIG. 3 is a schematic idealized curve showing voltage distribution across the resistant layer represented in FIG. 1;

FIG. 4 is a top view of an electrographic tablet which may be employed with the touch mode and pen mode features of the invention;

FIG. 5 is a side view of pen apparatus according to the invention illustrating its contact with a glass support surface of an electrographic tablet;

FIG. 6 is a sectional view taken through the plane 6-6 shown in FIG. 5;

FIG. 6A is a partial view showing a switch travel limiting member and mouth portion of a pick-up rod assembly employed with the invention:

FIG. 6B is an enlarged partial view of the region of the pen apparatus shown in FIG. 6;

FIG. 6C is a view similar to FIG. 6B but showing a switch function in an open condition;

FIG. 6D is a perspective view of a transition contact member employed with the pen apparatus of the invention;

FIG. 7 is an exploded view of the pen apparatus of the invention;

FIG. 8 is an enlarged top view of a pick up rod assembly and associated cartridge enclosure forward region;

FIG. 9 is a top view of a printed circuit board employed with the pen apparatus of the invention;

FIG. 10 is a bottom view of a printed circuit board employed with the pen apparatus of the invention;

FIG. 11 is a schematic representation of shielded cable interference within an electrographic terminal during a touch mode of performance;

FIG. 12 is an electrical schematic diagram of a shield drive circuit;

FIG. 13 is a schematic representation of cable shield voltages during a pen mode and a touch mode of system operation;

FIG. 14 is an electrical schematic diagram of a pen-contained amplification network and pen orientation detection network;

FIG. 15 is a schematic curve and timeline showing pen-up and pen-down functions;

FIG. 16 is a schematic view illustrating capacitive coupling of the pen apparatus of the invention corresponding with the timeline of FIG. 15;

FIG. 17 is an equivalent circuit showing a filtering function assuring shield ground conditions during a pen mode of system operation;

FIGS. 18A and 18B combine as labeled thereon to show a process for assembling the pen apparatus of the invention;

FIG. 19 is an exploded view showing portions of the fabrication process described in connection with FIGS. 18A and 18B;

FIG. 20 is a top view of a cartridge enclosure component with a transition contact member having been located therein; and

FIG. 21 is a top view of an oppositely disposed cartridge enclosure component.

### DETAILED DESCRIPTION OF THE INVENTION

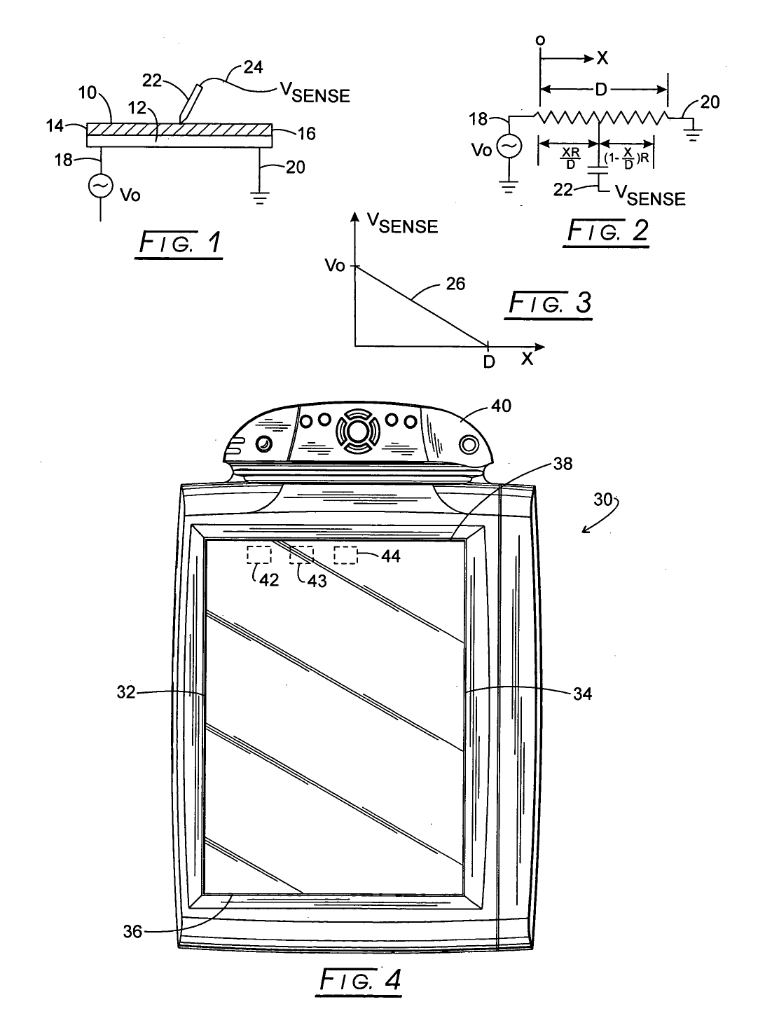

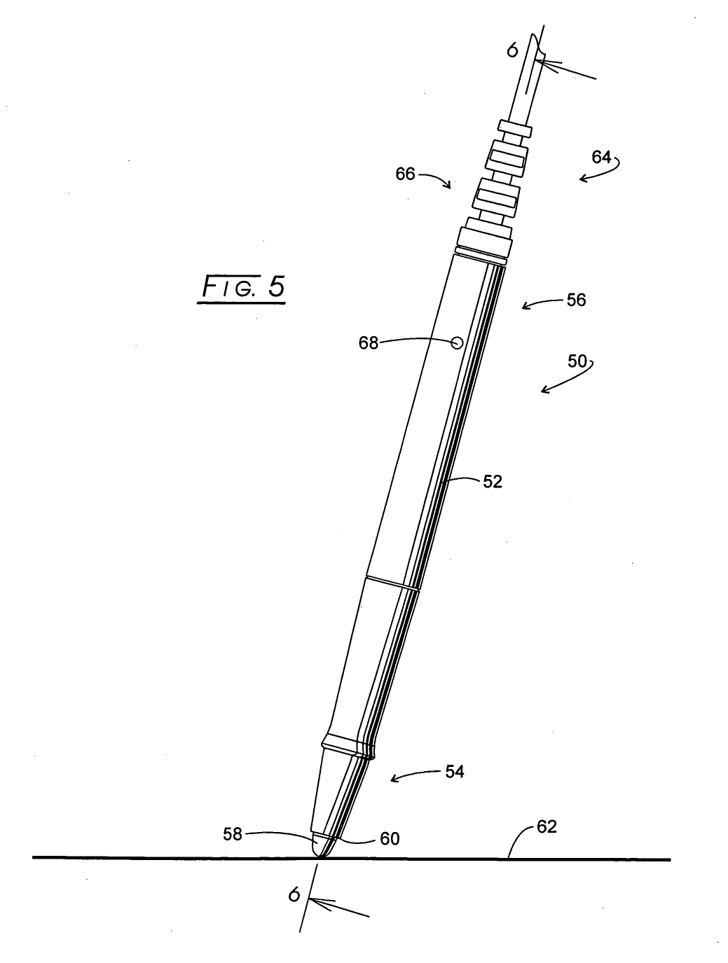

As a preliminary consideration of the general approach taken with resistant surface electrographic technology, reference is made to FIGS. 1 and 2 wherein an idealized one-dimensional model is revealed. In FIG. 1, an insulative support 10 such as glass is shown overlaying and supporting a resistive layer of, for example, indium-tin oxide 12. Electrodes 14 and 16 are shown coupled to the resistive layer 12 at the opposite ends or borders thereof. Electrode 14 is coupled with an a.c. source designated V₀ from line 18, while electrode 16 is coupled to ground through line 20. A pen 22 is positioned in contact with the glass support 10 which, through capacitive coupling serves to pick-up a voltage output at line 24, such voltage being labeled Vₛₑₙₛₑ. The equivalent circuit for this idealized one-dimensional model is represented in FIG. 2 where the resistive layer 12 is shown as a resistor and the distance of the pen 22 from the edge of the resistor closest to the source V₀ is represented as “X”. “D” represents the distance between electrodes 14 and 16. That fraction of resistance of layer 12 which extends from the source of voltage excitation to the location, X, may be represented as XR/D, while the resistance from the location of the pen 22 to the opposite electrode as at 16 or line 20 may be represented as the labeled value (1−X/D)R. The corresponding idealized value for Vₛₑₙₛₑ is shown in FIG. 3 as being linear as represented at the curve 26. As a result of a variety of phenomena, such linearity becomes an approximation, however, achieving adequate linearity prior to the application of necessary electronic treatment has been seen to be highly desirable.

To derive signals representing coordinate pairs with respect to the position of the pen 22 on the resistive surface 12, measurements of the voltage Vₛₑₙₛₑ are made along orthogonally disposed axes designated x and y. Through the utilization of switching, the application of the voltage source as through line 18 and connection of ground as through line 20 as shown in FIG. 1 are alternately reversed for each of the x and y coordinates. With the values thus obtained, for each designated x and y coordinate, a difference/sum voltage ratio is determined to obtain a coordinate position signal.

Looking to FIG. 4, a digitizer tablet with which the pen apparatus of the invention may perform is represented generally at 30. Tablets as at 30 may be developed having a broad variety of overall shapes and sizes from small and compact to relatively large. The devices generally are structured as a patterned layer of indium-tin oxide (ITO) which is deposited over a transparent glass support. The borders of the glass which support an x-coordinate orientation may be observed at 32 and 34, while the borders of the glass for the y-coordinate consideration are seen at 36 and 38. The resistive layer supported on glass is transparent but is deposited in pattern such that the deposit itself is thick enough to avoid resistivity drift due to surface effects while maintaining desired resistivity characteristics. Techniques for achieving this stability are described in the above-noted U.S. Pat. No. 4,665,283. In general, for smaller tablets having overall boundary sizes of about 12 inches by 12 inches, for example, a generally desirable value of resistivity of 600 ohms per square is employed along with an excitation, for example, at 120 KHz. For larger tablets, the resistivity preferably is altered to 900 ohms per square. However, for typical applications of digitizer tablets, it is desirable to maintain the resistivity under 1,000 ohms per square to avoid hand effects and the like. Also seen in FIG. 4 is the polymeric housing 40 which retains the circuitry employed in operation of the tablet. Not shown in the figure is a pen connecting cable assembly. The ITO layer pattern and the tablet drive is described in the above-noted U.S. Pat. No. 4,853,493 which is incorporated herein by reference. In accordance with the teachings of that patent, only four corners are primarily assessed by the circuitry of the device with a utilization of corner positioned L-shaped electrodes.

Where the system incorporating tablet or terminal 30 operates in both a pen mode and a touch mode, at least when in the touch mode finger touch regions such as shown at blocks 42-44 will be visible. These regions as at 42-44 delineate the position which the user will touch with a finger to carry out system interaction.

Looking in more detail to the sum/difference ratio procedure employed with tablets as at 30, the output of the pen 22 may be termed XPLUS when an A.C. voltage source is applied along the x+ coordinate direction from appropriate adjacent corners of tablet 30 while simultaneously, ground supplied to the opposite, x-corners. Arbitrarily designating XMINUS to be the signal at pen 22 when the opposite condition obtains wherein the A.C. voltage source is applied to the x-coordinate adjacent corners of the resistive layer and ground is applied to the oppositely disposed, x+ edge; designating YPLUS to be the signal at pen 22 when the A.C. voltage source is applied to the adjacent corners of the resistant layer at the y+ coordinate and ground is applied to the opposite or y− coordinate adjacent corners; and designating YMINUS to be the signal derived at pen 22 when the A.C. voltage source is effectively applied along the adjacent corners of the resistive layer at the y− coordinate position thereof, while ground is applied at the adjacent corners of tablet 30 represented at the y+ side. With the arrangement, coordinate pair signals may be derived and signal values may be employed with a difference/sum ratio to derive paired coordinate signals for any position on the active surface of the tablet as follows:

$$position x = \frac{( XPLUS ) - ( XMINUS )}{( XPLUS + ( XMINUS}$$

$$position y = \frac{( XPLUS ) - ( YMINUS )}{( YPLUS ) + ( YMINUS )}$$

Looking to FIG. 5, a pen for collecting position signals from an electrographic surface in accordance with the invention is represented generally at 50. Pen 50 is illustrated with a generally cylindrical outer housing 52 which extends along the pen axis represented by the 6-6 section line from a tip region represented generally at 54 to a cable support region represented generally at 56. At the tip region 54 a polymeric and dielectric pen tip 58 is seen extending from the mouth 60 of outer housing 52. Pen tip 58 is illustrated in contact with the surface of a glass support 62 of an electrographic tablet.

Rearward cable support region 56 is seen supporting a cable assembly represented generally at 64 which is configured having integrally molded stress relief nodules represented generally at 66. The cable will be seen to support an array of four input/output leads. These input/output leads are surmounted by an electrically conductive sheath (not seen). It is this sheath that is maintained at ground and, in fact provides ground to pen 50 during the pen mode of operation. During a touch mode of operation of the system, the sheath is driven with an a.c. signal identical to or emulating that driving the corners of tablet 30. Also seen in the figure is a detent or dog receiving hole 68. An identically positioned hole is located symmetrically opposite that of 68.

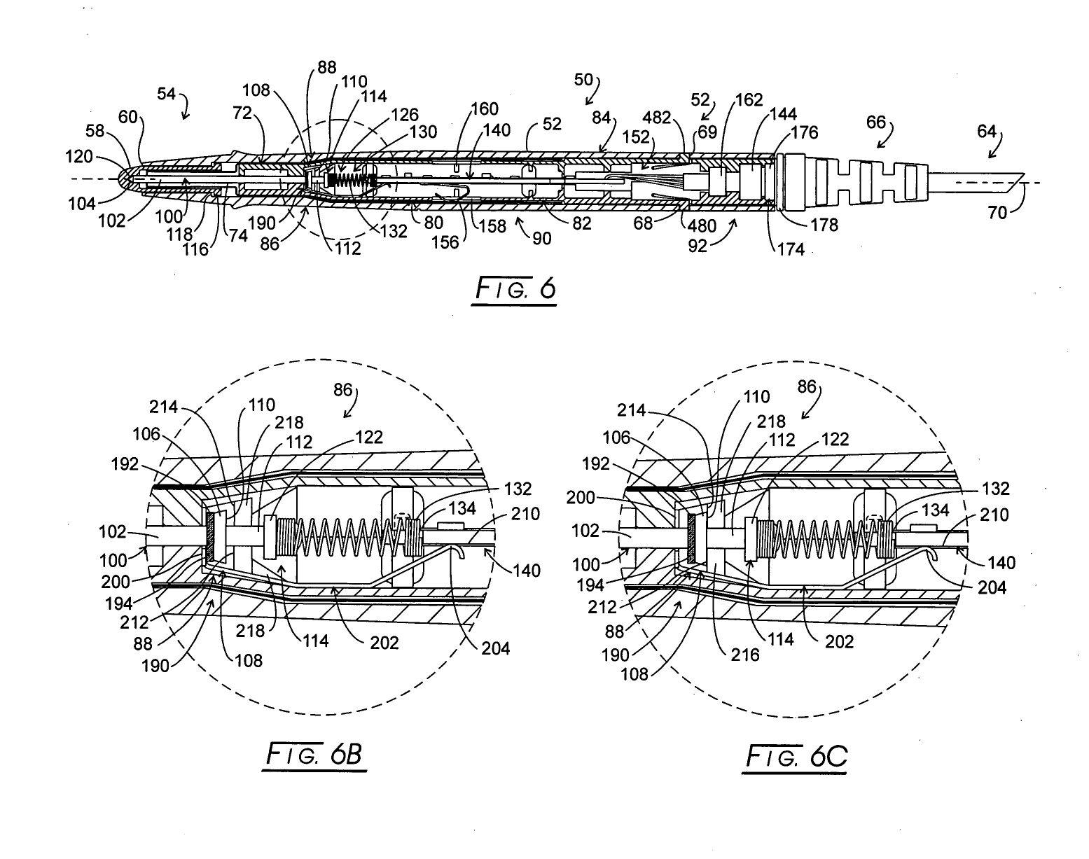

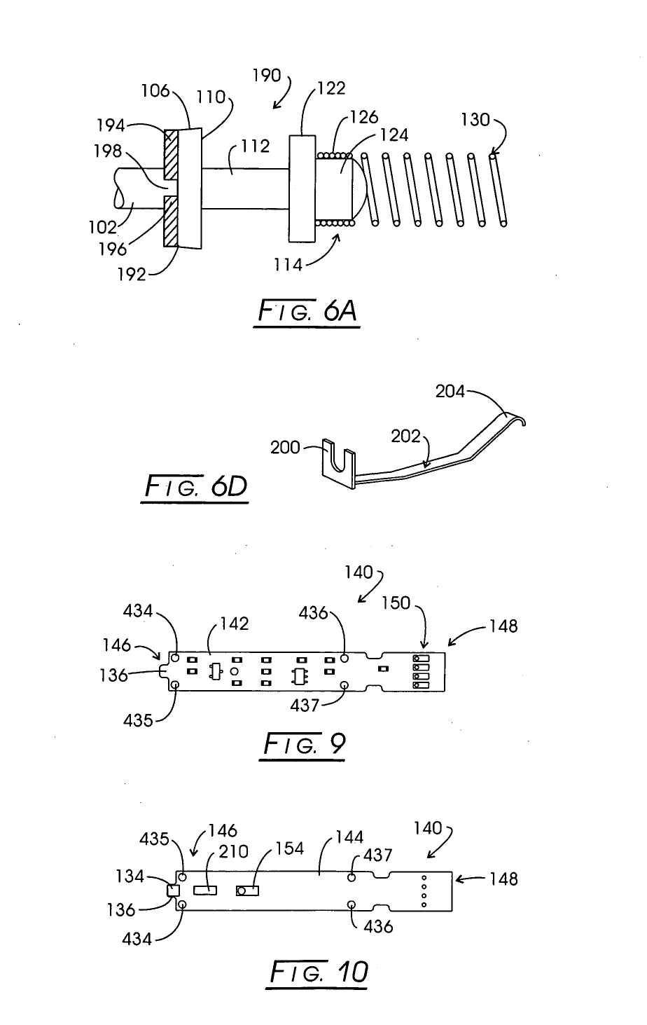

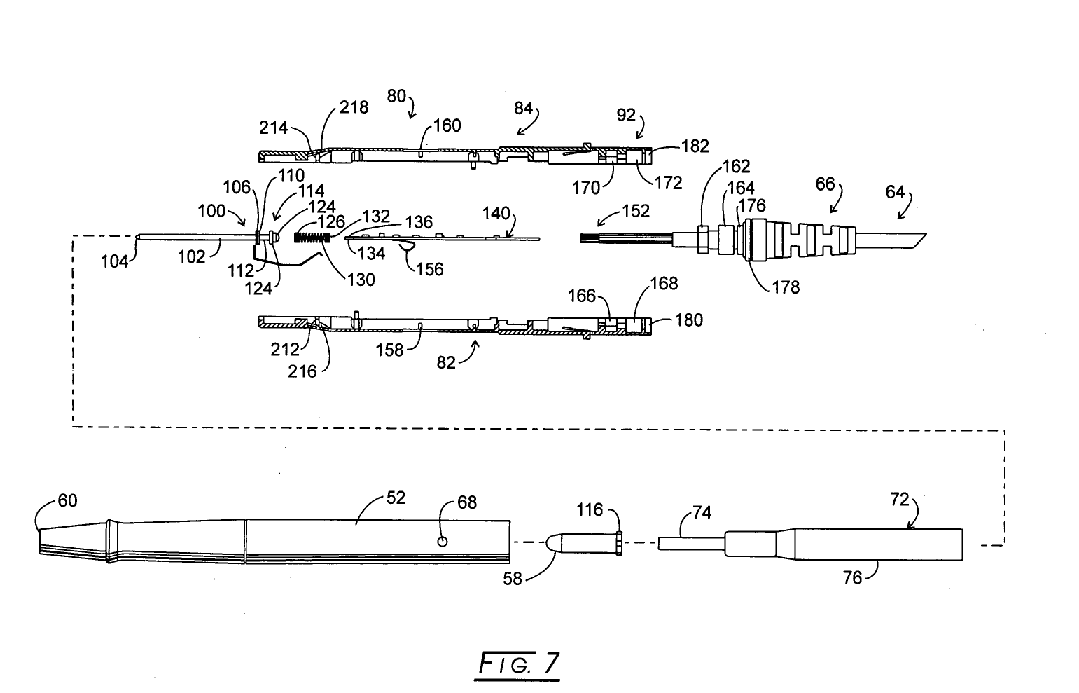

Referring to FIG. 6, pen 50 appears in sectional view disposed about pen axis 70. Within the outer housing 52 there is slideably located a brass electrostatic shield represented generally at 72. As seen additionally in FIG. 7, shield 72 is configured with a necked-down portion 74 which is integrally formed with and extends forwardly from a sleeve portion 76. Slideably inserted within the shield sleeve portion 76 is a generally cylindrical polymeric cartridge enclosure represented generally at 80. As seen in FIG. 7, cartridge enclosure 80 is configured with a pair of identically structured generally half cylindrical cartridge enclosure components represented generally at 82 and 84. When abuttably joined together components 82 and 84 define a forward region represented generally at 86 having a containment or switching cavity 88; an intermediate region represented generally at 90; and a cable engagement region represented generally at 92. With the above-discussed insertive relationship between cartridge enclosure 80 and shield 72, a robust structural aspect is realized. However, it should be observed that an equivalent and effective electrostatic shielding function may be derived with other approaches. For instance, such an electrostatic shield may be implemented as an electrically conductive coating or foil carried by the cartridge enclosure 80 or housing 52.

Slideably extending through the forward region 86 of cartridge enclosure 80 and through the necked-down portion 74 of electrostatic shield 72 is a pick-up or transmission rod assembly represented generally at 100. Assembly 100 is configured with a rod-shaped portion 102 which, as seen in FIGS. 6 and 7, extends from a tip 104 to an annular collar-shaped integrally formed switch travel limiting member, 106 which is a component of a pen orientation switch assembly represented generally in FIG. 6 at 108. Component 106 functions as a switch travel limiting member with a rearwardly disposed annulus-shaped stop side 110. From side 110 the pick-up rod assembly extends as shown at rod extension 112 to a spring engageable mount portion represented generally at 114. Switch travel limiting member 106 is slidable with the assembly 100 within containment cavity 88. With this arrangement, the extent of motion of the assembly 100 is limited to a very small extent wherein the pen user is given the physical impression of an ink pen on paper when the pen 50 is positioned as shown in FIG. 5. FIGS. 6 and 7 further reveal that the polymeric/dielectric pen 58 is slideably mounted over the necked-down portion 74 of electrostatic shield 72 and is retained at the mouth 60 of outer housing 52 by an outwardly depending integrally formed rearward collar 116 which is freely abuttably contactable with a corresponding annular ledge seen in FIG. 6 at 118 formed with an outer housing 52. FIG. 6 further reveals that tip 58 is internally configured having a tip-receiving cavity 120 which abuttably receives tip 104 of pick-up rod assembly 100. Cavity 120 additionally functions to align the rod-shaped portion 102 of pick-up rod assembly 100 within neck-down portion 74 of shield 72 (FIG. 7).

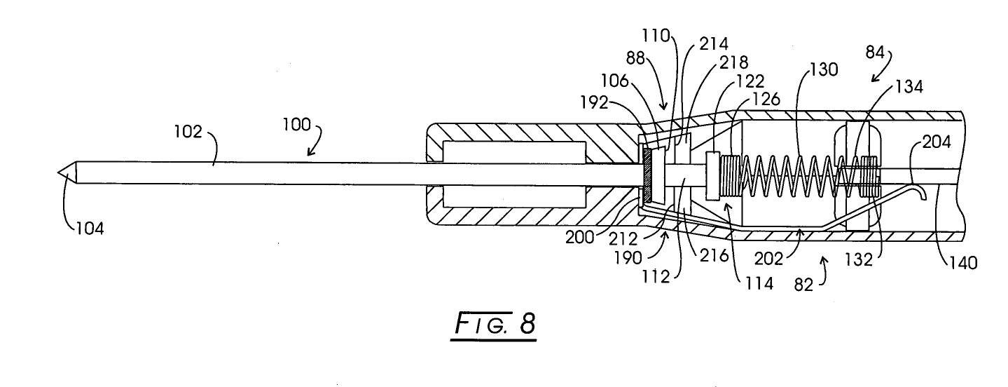

FIGS. 6A and 7 reveal that spring engageable mount portion 114 is configured with a compression collar 124 integrally formed with rod extension 112 and a spring alignment nub 124. FIGS. 6A and 8 further reveal that collar 122 and alignment nub 124 are coupled by solder to the forward connector portion 126 of a helical spring represented generally at 130. Formed, for example, of beryllium-copper, spring 130 functions as a portion of the pen circuit as well as to mechanically forwardly bias pick-up rod assembly 100. In this regard, spring 120 extends rearwardly along pen axis 70; is soldered at its rearward or anchor end to a junction 134 carried by an axially aligned tab 136 (FIG. 10) carried by an elongate narrow printed circuit board represented generally at 140. Circuit board 140 is mounted in the intermediate region 90 of cartridge enclosure 80 and carries a signal treatment or amplification network the input to which is coupled with helical spring 130 at junction 134. Additionally, circuit board 140 supports. a pen orientation detector network determining whether pen 50 is in a pen-up or a pen-down interaction orientation. It will be seen to be uniquely carried out utilizing the input bias developed at the amplification signal treatment network. Looking additionally to FIGS. 9 and 10, circuit board 140 is configured having oppositely disposed surfaces designated as an upper surface 142 (FIG. 9) and a lower surface designated 144 (FIG. 10). The component 140 extends between a forward end represented generally at 146 and a rearward end represented generally at 148. As seen in FIG. 9, an array of four input/output terminals is located adjacent the rearward end 148 of circuit board 140. FIG. 6 reveals that these terminals are soldered with a corresponding array 152 of four leads within cable assembly 64. One of the leads of array 142 carries a filtered ground condition emanating from a sheath within cable 64. This ground is distributed, inter alia, to a junction 154 seen in FIG. 10 and located at the underside 144 of printed circuit board 140. FIGS. 6 and 7 reveal a resilient electrical contact 156 which conveys this ground to electrostatic shield 72 at its sleeve portion 76. Engagement is made through a rectangular opening 158. Cartridge enclosure component 84, being identically configured, also is formed with such an opening as seen at 160 in FIG. 7.

FIGS. 6 and 7 further reveal that cartridge enclosure 80 as is represented by components 82 and 84 is configured at its cable engagement region 92 to mechanically surmount the integrally molded engagement components 162 and 164 of cable assembly 64. In this regard, FIG. 7 reveals that cartridge enclosure component 82 is configured with engagement cavities 166 and 168 which surmount one half of respective components 162 and 164, while cartridge enclosure component 84 is configured with engagement cavities 170 and 172 configured to surmount the opposite half of those engagement components. Located rearwardly of engagement cavities 168 and 172 is a seating cavity shown generally at 174 in FIG. 6 which receives and is covered by cap members 176 and 178 of cable assembly 64. FIG. 7 reveals that the cavity 174 is configured from half cylindrical cavity components 180 and 182 formed within respective cartridge enclosure components 82 and 84.

Current pens intended for electrographic performance generally employ a costly and somewhat inefficient switching technique to derive necessary pen-up and pen-down orientation signals. For instance, to close a normally open switch requires a somewhat elaborate scheme as well as a generally physically recognizable mechanical motion for switch closure. With the instant design, and with the design described by Kable, et al., in United State application Ser. No. 11/360,220 (supra), a significant number of switch parts are eliminated and the pick-up rod assembly motion required for switch actuation is essentially not noticeable by the user. The present design represents an improvement with respect to switch test cycle life span to failure. In this regard, the test cycle life span increases from hundreds of thousands to several million. FIGS. 6B, 6C and 8 reveal the proved and simply fabricated pen orientation switching function as represented in general at 190. In FIGS. 6B and 8 the switching function 190 is represented in its normally closed orientation. The figures reveal that the switch travel limiting member 106 within containment or switching cavity 88 is configured with a forward facing switch surface against which is located a contact surface or component 194 Contact surface 194 is provided as a conformable electrically conductive material such as a carbon-filled silicon polymeric material. Returning momentarily to FIG. 6A, contact surface or component 194 is developed by an annular member having a central opening 196 which elastically engages a relief 198 formed within rod component 102 of pick-up rod, assembly 100. Contact surface 194 is axially mechanically biased forwardly by helical spring 130 at its spring engagement mount portion 114.

FIGS. 6B and 8 show the switching function 190 in its normally closed orientation wherein spring 130 mechanically biases contact surface or component 196 against the U-shaped contact portion 200 of a transition contact member represented generally at 202 and illustrated in perspective fashion in FIG. 6D.

Member 202 extends rearwardly to a resiliently biased rearward contact 204 which engages the pad-like junction 210 located adjacent the forward end 146 of printed circuit board 140 as seen in FIG. 10. With the arrangement shown, a tip switch input representing either a pen-up orientation or a pen-down orientation is promulgated from contact 204 to the input of a pen orientation detector network located on circuit board 140 and having an output at terminal array 150. The normally closed orientation of the switching function 190 seen in FIGS. 6B and 8 corresponds with a pen-up condition. Utilization of the conformal contact surface or component as at 194 substantially improves the contact reliability of the switch contact function inasmuch as essentially an infinite number of contact points are established. Additionally, by providing the transition contact member 202 as a stamped metal part switch simplicity is achieved with attendant lower cost. In the closed orientation shown, the contact member 202 conveys a voltage bias developed at the input of the signal treatment or amplifying network to the pen orientation detector network. No soldering is involved in developing this transition function. Note additionally that the switching function 190 is retained within the earlier-described containment or switching cavity 88. Cavity 88 is configured to restrict the extent of axial motion of the switch function 190 into an open contact orientation. Because the actuation is from a normally closed switching condition to an open switching condition, only a very minor amount of movement is required to develop a pen-down tip switch signal. Accordingly, the cavity 88 is configured to permit as small a switch gap as possible to achieve a pen performance that appears to have virtually no movement that is detectible by the user. It is to be contrasted with much more movement being required to close the contacts of the normally open pen switching function. To improve the actuation cycle life of the switch function 190 cartridge components 82 and 84 are formed of a polycarbonate material which is more robust than, for example, a conventional ABS material. Additionally, by positioning switch travel limiting member 106 within cavity 88 in association with buttress reinforced stop surfaces cycle life spans are substantially increased as noted above. Each of the cartridges 82 and 84 is configured at cavity 88 to provide two transversely disposed stop surfaces such that a total of four such stop surfaces will be developed. Such features are illustrated in FIGS. 20 and 21. These stop surfaces are the forward surfaces of four buttressed wall components integrally molded within cartridge component 82 and 84. FIGS. 6B and 8 reveal a buttressed wall component 216 formed in cartridge component 82 with a stop surface 212 and a corresponding buttress of wall component 218 with stop surface 214 formed within cartridge component 84. Observation of the drawing reveals that these buttressed wall components each represent about % of a wall with an associated stop surface and each has an integrally formed rather triangularly shaped buttress which extends rearwardly. The four buttress wall components are configured such that there is a vertically disposed central slot (FIG. 20) extending through the wall. It is within this slot that transition contact member 202 is positioned and through such slot that the rod extension 112 slideably extends.

FIG. 6C reveals the orientation of the components of switching function 190 as a pen-down configuration is developed. The tip switch signal representing an open switch condition appears as soon as contact surface 194 moves from contact portion 200 of transition contact member 202. Note that the abuttable switch travel limiting surface 110 of the collar-shaped switch travel limiting member 106 has made freely abutting contact with the stop surfaces of the buttress wall components, stop surfaces 212 and 214 being seen in FIG. 6C. This provides a very positive and strong stop function enhancing the cycle life of the switching function 190.

As discussed above, electrographic terminals may be configured to operate in both a pen and a touch mode. In a pen mode, pick-up assembly 100 is at system ground as it makes interactive contact with the support surface of the electrographic terminal. As such, it derives pen position coordinate signals to provide a pen position output at certain of the shielded cable leads. Those outputs for the interactivity of the leads with a control system are shielded or protected by retaining the shield during a pen mode of operation at system ground. When the system is performing in a touch mode, the user finger contact with the terminal introduces ground to the current flowing from the corners of the terminal. Early in the introduction of combined touch and pen mode systems, it was found that the shielded cable from time to time would inadvertently touch the terminal and the location of that touch would be recognized as a ground by the control system to introduce error. Looking to FIG. 11, a terminal is schematically represented at 230 in conjunction with two of its corner drives. In the latter respect, one drive is shown as an a.c. source coupled to one corner of terminal 230 at line 234 and to ground at line 236. Similarly, an a.c. source or drive 236 is coupled to an opposite corner of terminal 230 as represented at line 238 and to ground as represented at line 240. A shielded cable is schematically represented at 242 which is connectable through a switching function, S1 to ground as schematically represented at line 244. Where the schematically portrayed system is in a touch mode, the point of contact of the cable 242 as represented at 246 would be recognized by the control system as a touch and induce error. The early approach to correcting for this situation was, during a touch mode, to drive the shield of cable 242 to exhibit a signal condition emulating the waveform derived from drive sources 232 and 236. Such a drive source is shown symbolically at 248 extending as represented at line 250 to the shield of cable 242 and coupled to ground as represented at line 252. With such an arrangement, the shield being driven with the same voltage waveform that's at the touch screen of terminal 230 the differential capacitance at point 246 is zero. When the system transitions into a pen mode, then that drive signal is diverted as represented by the closure of switch S1 and the shield is retained at ground.

Referring to FIG. 12, a typical shield drive network is represented generally at 260. Network 260 incorporates an operational amplifier 262 coupled to VCC via line 264 and VSS via line 266. The positive input to device 262 is from an a.c. cable drive source 266 via line 268, source 266 being coupled to ground via line 270. The output of amplifier 262 at line 272 incorporates resistor R1 and extends to connection with the shield of a cable. The negative side of device 262 is coupled via line 274 to line 272. A selectively diverting field effect transistor Q1 is shown coupled between line 272 and system ground. This transistor Q1 is selectively turned on and off by the host control system as represented by control line 276. Accordingly, when transistor Q1 is on, the a.c. signal at line 272 is diverted or sunk to ground to establish a pen mode condition for the cable shield. On the other hand, during a touch mode of operation, transistor Q1 is off and the tablet drive emulating signal is permitted to reach the cable shield.

Turning to FIG. 13, the shield voltage is schematically plotted with respect to pen mode and touch mode operation. In pen mode, as represented at level 280, ground is maintained. However, as the host system alters to a touch mode as represented at vertical dashed line 282, a sinusoid form of voltage is directed to the shield as represented at curve 284 having a total peak-to-peak voltage swing, for example, 6V emulating the electrographic tablet drive.

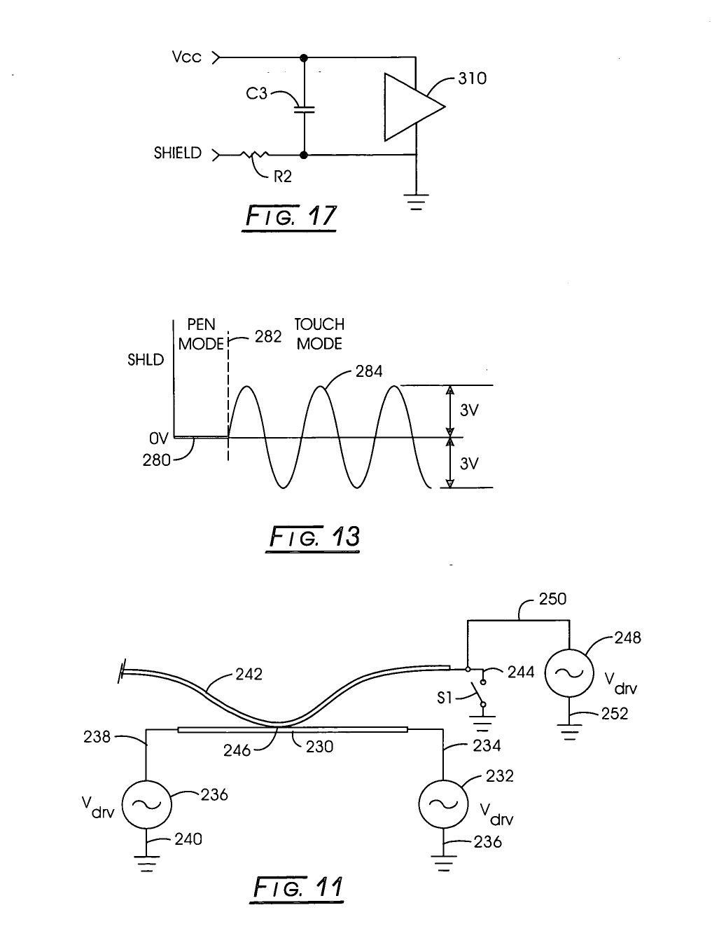

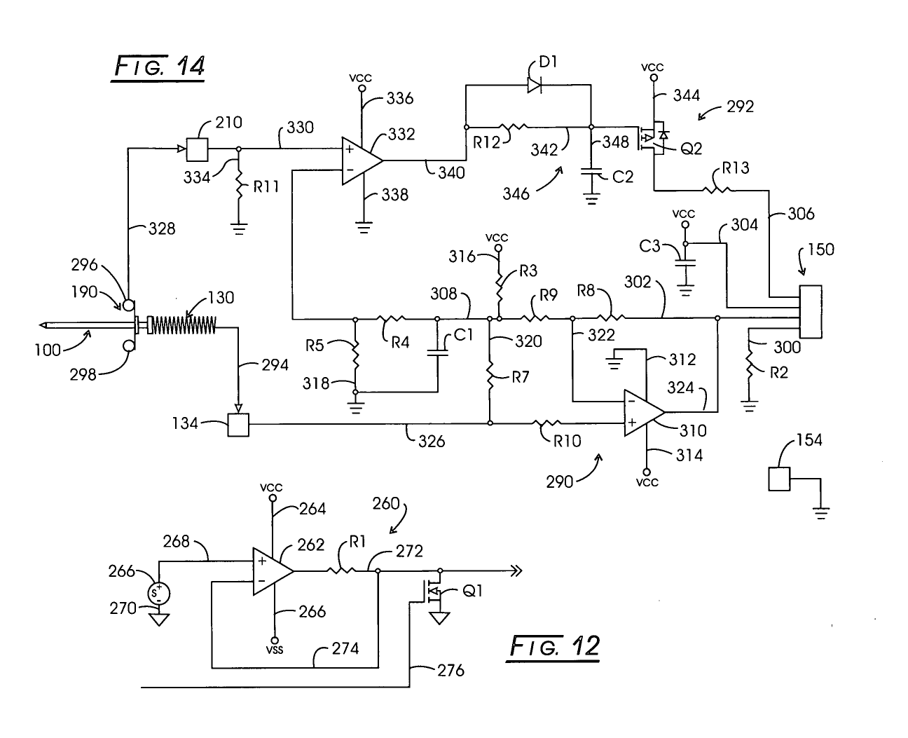

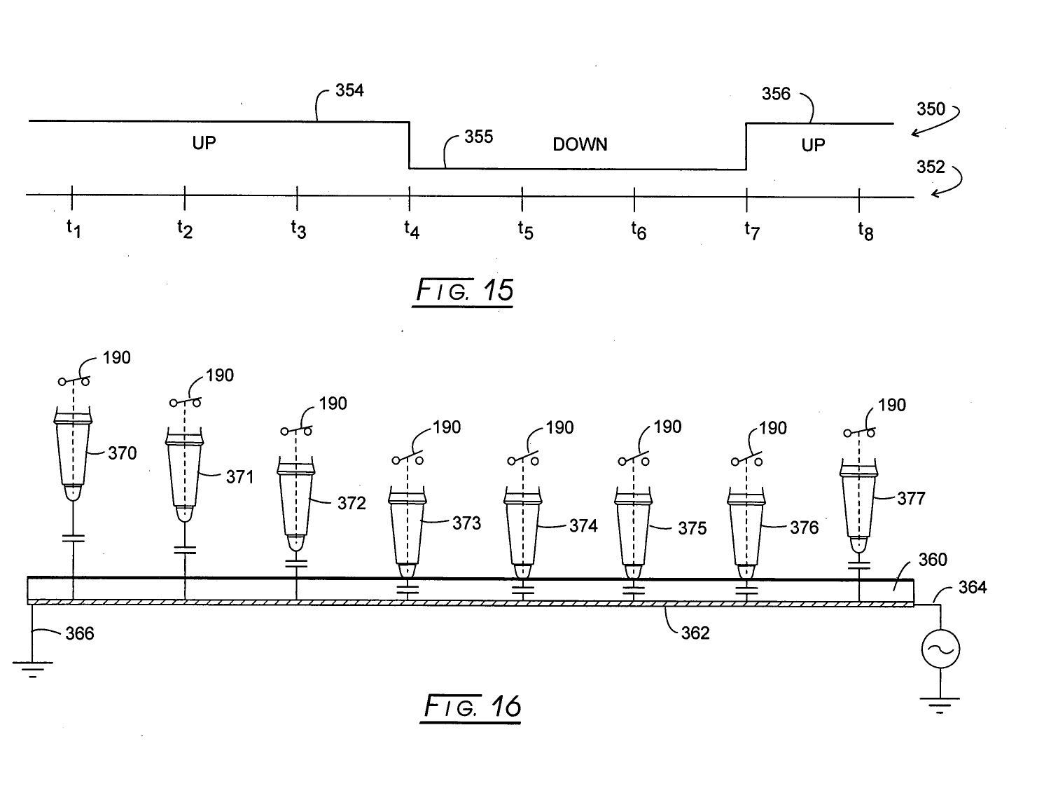

Referring to FIG. 14, the circuitry generally supported from printed circuit board 140 is revealed in schematic fashion. In general, the circuitry includes a signal treatment (amplification) network represented generally at 290 and a pen orientation detector network represented generally at 292. Network 290 is seen addressed by earlier-described junction 134 (FIG. 10) which, as represented by arrow 294 is electrically connected to the anchoring end of spring 130. Pick-up assembly 100 is schematically represented in conjunction with spring biased normally closed switching function 190 with the schematic terminals 296 and 298. Terminal array 150 reappears in block schematic form and is seen to provide, inter alia, a distributed ground as represented at line 300. Note, however, that a 1 K resistor, R2 has been incorporated within that line. An amplified a.c. pen position signal representing the earlier-described pen coordinate pairs is outputted at line 302. A single sided (+5V-ground) source (VCC) is inputted and distributed as represented at line 304; and a tip switch related output is provided at line 306 to identify a pen-up or pen-down orientation.

Now looking to signal treatment or amplification network 290, the network is seen to incorporate an operational amplifier 310 functioning as a buffering amplification stage supplying gain and impedance isolation. Amplifier 310 is coupled to ground via line 312 and to +5(VCC) or circuit supply power via line 314. Inasmuch as a single voltage source at +5V is present, it is necessary to bias amplifier 310, for instance, at somewhere within a range of 2-3.5V to permit a.c. amplification. For this purpose, +5V d.c.(VCC) at line 316 incorporating resistor R3 and extending to line 302 is applied to a node defined at the junction of lines 302, 308 and 320, i.e., at resistors R3 and R7. For the present example, the node is at 60% of VCC. Bias to the input line 326 to operational amplifier 310 is through resistor R7 which is of relatively high value (100Kohms) to avoid circuit disturbance. The gain of amplifier 310 (for example, 4.2) is set by resistors R8 and R9 at lines 302 and 322. Capacitor C1 between line 308 and ground functions to establish the bias point or node as an a.c. ground. With the arrangement shown, the a.c. input from pick-up rod assembly is applied to junction 134 and the input to amplifier 310 via line 326 and resistor R10. Amplifier 310 applies gain (4.2) and an output at lines 324 and 302 to a terminal at array 150 to drive the shielded cable assembly 64.

Turning to pen orientation network 292, with a pen-up condition switching function 190 will be closed as schematically illustrated. With such closure the bias at line 326 will be directed to junction 210 and line 330. Line 330 is directed to the negative input of an operational amplifier 332. Device 332 is coupled to VCC by line 336 and to ground via line 338, performing as a comparator with an output at line 340. A relatively large (22 Meg ohm) resistor R11 is provided at line 334 between bias carrying line 330 and ground to avoid disturbance at network 290. The opposite input to device 332 emanates from line 308 and divider resistors R4 and R5 which establish one-half the bias level. With switch function 190 closed (pen-up) the input (bias) at the positive terminal of device 332 is higher than that at the negative terminal so that output line 340 is at a logic high level. That level is transferred via diode D1 to line 342 and the gate of field effect transistor (FET) Q2. The source of transistor Q2 (line 344) being coupled to VCC, there is no biasing potential between gate and source and the device is off and the signal to the host system, via line 306 and resistor R13 is a logic low. Under this pen-up condition, capacitor C2 at line 348 is rapidly charged through diode D1.

Where a pen-down orientation then occurs, switching function 190 opens and the bias at the positive input (line 330) to comparator 332 is removed leaving the reduced-bias at its negative terminal. Now that terminal is of higher potential and the output at line 340 goes to ground. Diode D1 is back-biased and capacitor C2 discharges through relatively large (2M ohms) resistor R12 of delay network 346. A delay occurs before the gate of transistor Q2 is of low enough potential to turn the device on. When it then turns on a logic high occurs at line 306 and resistor R13. The host system will now accept pen position signals at line 302.

The combination of timing capacitor C2 and resistor R12 provides a delay network which functions to develop a universal accommodation of polluted coordinate data evolved in the course of pen movement into contact with the electrostatic surface where the voltage collected at the pen tip is used to determine position on the tablet. The voltage change on the pen tip must be due to the position change on the tablet as opposed to the height change off of the tablet. In FIG. 15, the vertical or z-axis orientation of the pen tip is represented generally at curve 350 which is aligned with a timeline represented generally at 352. With arbitrary time components, t₁-t₈, associated with pen-up maneuvers toward a pen-down position; a pen-down position; and a subsequent pen-up position. These positions are represented respectively at curve components 354-356. Note in this regard that curve component 354 represents the maneuvering of the pen tip towards the electrostatic surface over a period extending from time, t₁-t₄. At time, t₄, the pen tip is assumed to be down and in contact with the glass support. This pen-down orientation represented at curve component 355 extends from time, t₄-t₇. As the pen is then picked up, as represented at curve component 356, time components, t₇ and t₈, are defined.

Now looking to FIG. 16, a tablet glass support is represented at 360 underwhich a patterned electrographic surface such as indium-tin oxide is located as represented at 362. The borders of the tablet are coupled between an a.c. source and ground as represented respectively at lines 364 and 366. Those borders are switched as above-described, full measurements being required by excitation at different borders on the tablet. Such coordinate readouts are spaced apart in time as the pen tip approaches the glass surface 360. At times, t₁-t₄, vertical or z-axis pen tip distances above the surface of the glass support 360 will vary with tip or pen orientations as seen at 370-373. Switch function 190 will be in a normally closed orientation during this progression toward the surface of the glass and a capacitive coupling with electrostatic surface 362 will vary but will not represent x-y position but height. Inasmuch as the receiving system generally will not recognize this condition, it will attempt to create coordinate pair data which is invalid or polluted. Capacitance will be a function of not only the dielectric attribute of the glass surface 360 but also the air gap from the pen tip as well as the polymeric pen tip 58. At pen-down position 373 with the opening of switch function 190 the capacitance now is fixed and is represented by the dielectric aspects of pen tip 52 and glass 360. This capacitance attribute now is constant as represented by at curve portion 355 in FIG. 15 and in conjunction with pen orientations 373-376. The coupling capacitance is constant throughout the time range from, t₄-t₇. Voltage readouts during that pen-down interval will be accurate. At time, t₇, and pen orientation 376 the operator lifts the pen to a pen-up orientation; and switch function 190 closes for the curve component 356. The pen tip orientation as represented at 377 is above the surface of glass support 360 and switch function 190 is normally closed.

It is desirable to accommodate for such heights or z-axis coordinate pollution universally for all devices which may be in the field. In effect, it is desirable that the pen 50 be backwards compatible with essentially all forms of electrographic devices. Where systems are marketed with pen and tablet together along with control features, then the solution to this data pollution phenomena can be accommodated for in firmware. However, to provide a universally compatible pen, a delay is imposed commencing with pen-down position 373 and the opening of switch function 190. That delay is derived from the RC network represented generally at 346 in FIG. 14 comprised of capacitor C2 and resistor R12. This delay is generally not noticeable inasmuch as the sampling rate is on the order of about 10-20 milliseconds. At the transition to a pen-up orientation, for example, at time, t₇, shown in FIG. 15, it is desirable to send the tip switch signal or condition as quickly as possible into the system to avoid a new set of polluted or inaccurate coordinate signals. Thus network 346 is delaying during a transition to a down position and is quite fast in a transition from a pen-down position to a pen-up position.

As the technology associated with touch and pen mode systems progressed, it became apparent that shield drive operational amplifiers as at 262 were not performing properly. Electrographic surfaces were being driven at higher voltages sometimes referred in the art as “harder”, for example, reaching 5-6V peak-to-peak as represented in FIG. 13 at curve 284. Circuit system voltage, Vcc for example, at 5V would be added to peak-to-peak voltages, reaching 10V or larger to exceed the ratings of operational amplifiers as at 310. This resulted in large current flows at Vcc (314) and ground (312). With these large currents the drive circuits as described in connection with FIG. 12 were no longer able to drive the cable shield at voltages mimicking the electrographic surface drive signals. This resulted in a loss of the above-noted zero differential capacitance between the shield and the graphic surface. The initial correction was to incorporate a 1K resistor (FIG. 14) within line 300 as identified at R2. Thus positioned, resistor R2 is in series with ground and limits the voltage across operational amplifier 310 to that within the specified ratings and, thus, limits the amount of current required from the drive function of the operational amplifier (262). A collateral problem with the pen position signals took place because the operational amplifiers as at 310, now being current limited by resistor R2, were not able to function with respect to their specification. This anomaly was corrected with the addition of capacitor C3 in association with line 304. The presence of capacitor C3 now created a charge reservoir for operational amplifier 310. In essence, an R-C filter was created with capacitor C3 and resistor R2. Looking to FIG. 17, the equivalent circuit for the change is shown, in effect, the a.c. signal is filtered out, no large voltage peak-to-peak swings were imposed upon the amplifier and a charge reservoir for the proper operation of amplifier 310 was created. The R-C filter is filtering the enabling power input to the operational amplifier and functions to filter the ground input to VCC whereas traditionally such a filter is to ground.

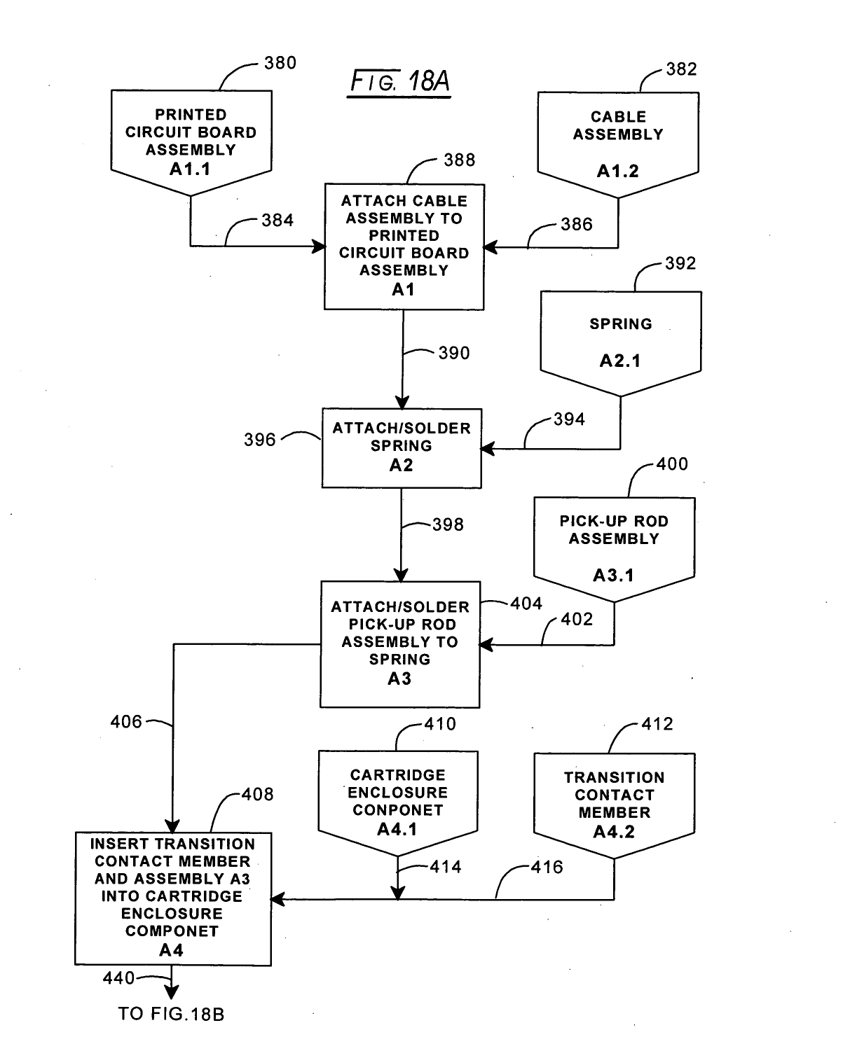

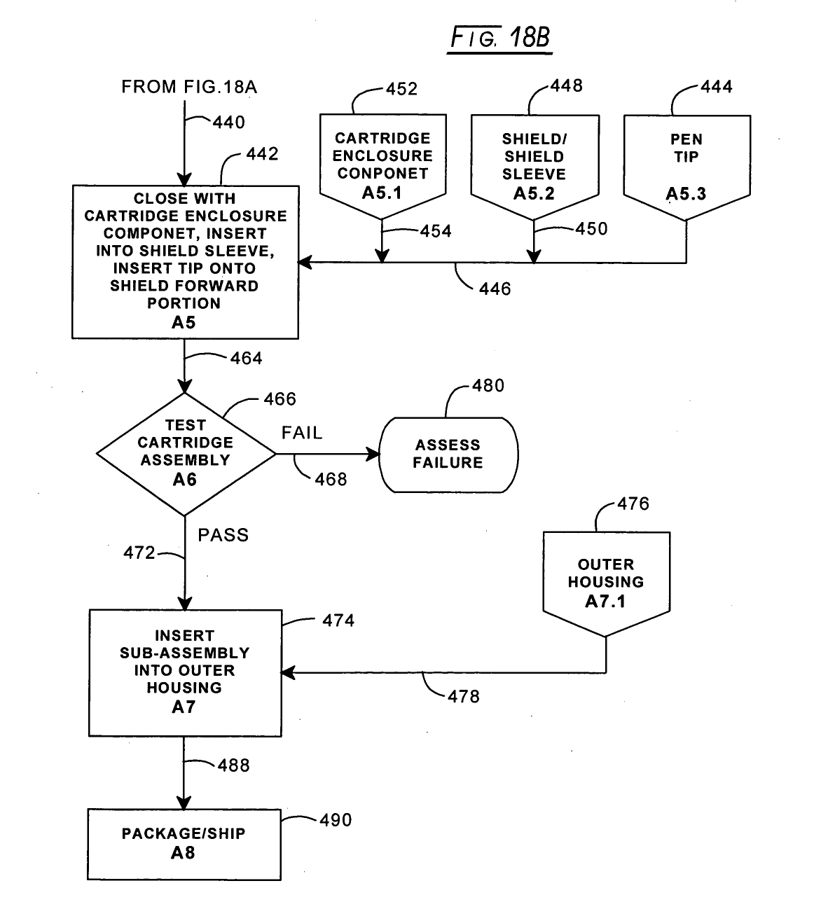

The assembly pen 50 is carried out utilizing a minimum number of parts as well as joint soldering procedures. Switching function 190 with its quite simple stamped metal transition contact member 202 evokes reliability and lower cost. As another aspect of this advantageous simplicity, the assembly of the pen is carried out in what may be termed an axial fashion. The assembly procedure is outlined in connection with FIGS. 18A-18B which should be considered together as labeled thereon. In the figures, those blocks having a triangular lower border are considered to be parts or components while the rectangular blocks are descriptive of the assembly operation associated with parts or the like. Referring to FIG. 18A, a printed circuit board assembly as at 140 which is combined with a grounding contact 156 (FIG. 7) is provided as represented at block 380. Additionally, a cable assembly as at 64 is provided as represented at block 382. These components additionally are respectively identified as A1.1 and A1.2. As represented at arrows 384 and 386 and operation A1 at block 388, the cable assembly is attached to the printed circuit board assembly, the four leads of lead array 152 (FIG. 7) being soldered to terminal array 150 (FIG. 9). The procedure then continues as represented at arrow 390 and block 392. At block 392 the helical spring 130 (FIG. 7) is provided as a component A2.1 and is available as represented at arrow 394 the operation at block 396 identified as A2. This procedure provides for the attachment and soldering of spring 130 at its rearward or anchor end 132 to junction 134 (FIG. 10) of printed circuit board 140. The spring is symmetrically aligned about the pen axis 70 (FIG. 6).

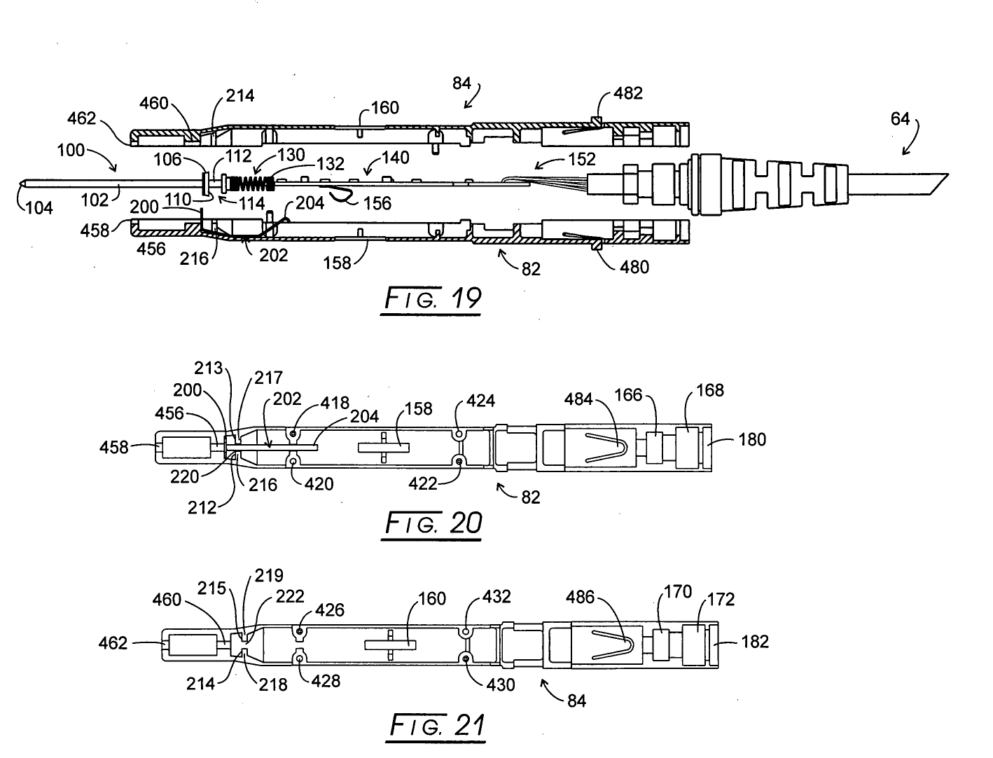

Looking momentarily to FIG. 19, the assembly thus far developed is seen to include the cable assembly 64 and its lead array 152 which is coupled to the array of terminals 150 on the upward side of the rearward portion of circuit board 140. The anchor or rearward end of 132 is spring 130 has now been connected to be aligned with the pen axis and soldered to junction 134 as described in connection with FIG. 10. Returning to FIG. 18A, as represented at arrow 398, the procedure looks to the pick-up rod assembly 100 identified as component A3.1 and shown in block 400. As represented at arrow 402 and block 404 the compression collar 122 and associated spring alignment nub 124 of the pick-up rod assembly 100 is soldered to the forward end or forward connector portion 126 of spring 130. This procedure is identified as A3 and, as seen in FIG. 19, the pick-up rod assembly 100 is connected for alignment with the pen axis as is the spring 120, circuit 140 and lead array 152. This defines a sub-assembly locatable about the pen axis. Next, as represented at arrow 406, the procedure continues to block 408 providing for the insertion of the transition contact member 202 as well as the sub-assembly A3 into one cartridge enclosure component. In this regard, a cartridge enclosure component is made available as represented at block 410 as identified at A4.1 and a transition contact member is made available as represented at block 412 and identified as component A4.2. The delivery of these components is represented by arrows 414 and 416. Looking momentarily to FIG. 20, transition contact member 202 is seen to be positioned upon an upwardly facing cartridge enclosure 82. The figure reveals buttress wall components 216 and 217 defining respective stop surfaces 212 and 213 as well as a slot 220 extending between them along the pen axis. With this arrangement, the U-shaped portion 200 (FIG. 6D) is upwardly oriented within one half of the containment cavity 88. Member 202 is maintained in alignment by two bolsters, one of which is configured with an integrally formed alignment pin 418. The opposite bolster is seen to be configured with an integrally formed alignment hole 420. Spaced rearwardly from alignment pin 418 and alignment hole 420 are corresponding integrally formed alignment pin 422 and alignment hole 424.

As noted above, cartridge enclosure component 84 is identically structured. Looking to FIG. 21 a top view of component 84 is revealed. Component 84 incorporates the opposite half of the containment cavity 88 and incorporates buttressed wall components 218 and 219 and respective associated stop surfaces 214 and 215. Between the buttress wall components 218 and 219 there is a slot 222. Rearwardly from components 218 and 219 and spaced apart bolsters, one carrying an alignment pen 426 corresponding with pen 418 and an alignment hole 428 corresponding with alignment hole 420. Spaced still rearwardly from the component are alignment pens, 430 corresponding with pen 422 and an alignment hole 432 corresponding with alignment hole 424. FIGS. 9 and 10 reveal that printed circuit board 140 is configured with four alignment through-holes 434-437. These alignment through-holes 434-437 are located to receive the alignment pens as at 418, 422, 426 and 430 as shown in FIGS. 20 and 21.

Returning to FIG. 18A, looking to arrow 440 which reappears in FIG. 18B, as represented at block 442 procedure A5 is carried out in conjunction with pen tip 58 as represented at block 444, component A5.3 and arrow 446; shield 72 as represented at block 448 and arrow 450; and cartridge enclosure component 84 as represented at block 452 and arrow 454. Returning to FIGS. 19-21, the rod component 102 of pick-up assembly 100 is slidably mounted upon grooves 456 and 458 which are upwardly facing in cartridge enclosure component 82. In similar fashion, grooves 460 and 462 are positioned over the rod portion 102 to provide a confined slideable engagement. With the definition of the cartridge enclosure, the sleeve portion 76 of electrostatic shield 72 (FIG. 7) is positioned over the forward portion of the cartridge enclosure to secure those members together and tip 58 is positioned over the necked-down portion 74 of the shield 72. Pen tip 58 functions to engage the tip 104 of the pick-up rod 100 assembly and align it within the necked-down portion 74 of electrostatic shield 72. Next, as represented at arrow 464 and block 466, as a procedure A6, the assembled cartridge assembly with shield and tip is tested. In the event of a failure of such test, as represented at arrow 468 and block 480, the tip failure is assessed. Where the test is passed, then as represented at arrow 472 and block 474, as a procedure A7 the sub-assembly thus far developed is slideably inserted into the outer housing 52. In this regard, as represented at block 476 and arrow 478, the outer housing is provided as a component A7.1. Returning momentarily to FIGS. 19-21, each of the cartridge enclosure components 82 and 84 is configured with integrally molded detent dogs or connectors shown respectively at 480 and 482. Dogs 480 and 482 (FIG. 19) are configured to flex inwardly by virtue of an integrally molded spring portion thereof shown respectively at 484 and 486 in FIGS. 20 and 21. As the procedure A7 at block 474 is carried out, these dogs 480 and 482 will resiliently engage holes in the outer housing 52, one of which has been identified at 68 in FIGS. 5 and 7, the opposite one of which is identified at 69 in FIG. 6.

Finally, as represented at arrow 488 and block 490 in FIG. 18B, identified as procedure A8, the completed pen is packaged and shipped.

Since certain changes may be made in the above-described apparatus, method and system without departing from the scope of the embodiments herein involved, it is intended that all matter contained in the description thereof or shown in the accompanying drawings shall be interpreted as illustrative and not in a limiting sense.

1. Pen apparatus for deriving position signals from an electrographic surface, comprising:
an outer housing generally extending along a pen axis from a tip region to a cable support region;
a pick-up rod assembly within the outer housing slideably disposed along said pen axis, having a tip located at said housing tip region interactable with said surface and extending to a pen orientation switch assembly with a switch travel limiting surface and further extending to a spring engageable mount portion;
a cartridge enclosure mounted within said outer housing extending between said tip region and said cable support region, configured to support said pick-up rod assembly, having a switching cavity configured to receive said switch assembly and having a stop surface abuttably engageable with said travel limiting surface to limit the extent of movement of said pick-up rod assembly, said spring engageable mount portion extending rearwardly of said stop surface;
a spring within said cartridge enclosure having a forward end coupled with said spring engageable mount portion in forward spring biasing relationship therewith and extending along said pen axis to an anchoring end;
a signal treatment network within said cartridge enclosure having an input exhibiting a bias voltage electrically coupled with said pick-up rod assembly and having a pen position signal output at said cable support region; and
a pen orientation detector network within said cartridge enclosure responsive to the condition of said switch assembly to provide outputs at said cable support region corresponding with the pen-down interaction or pen-up non-interaction of said pick-up rod assembly with said electrographic surface.

2. The pen apparatus of claim 1 in which:
said cartridge enclosure is formed of a polycarbonate material.

3. The pen apparatus of claim 1 in which:
said spring is electrically conductive and is supported within said cartridge enclosure at said anchoring end from connection with said signal treatment network.

4. The pen apparatus of claim 1 further comprising:
an electrostatic shield within said outer housing configured to effect an electrostatic shielding of said signal treatment and pen orientation networks, said spring, and said switch assembly.

5. The pen apparatus of claim 1 further comprising:
an electrostatic shield mounted within said outer housing, extending over at least that portion of said cartridge enclosure supporting said signal treatment and pen orientation detector networks, said spring, said switch assembly and is configured with a necked-down portion extending from said cartridge enclosure at said tip region to shield a substantial portion of said pick-up rod assembly.

6. The pen apparatus of claim 5 further comprising:
a polymeric, electrically insulative pen tip slideably mounted upon said electrostatic shield at said necked-down portion, engaged with said pick-up rod assembly tip and moveable therewith to define said pen-down interaction or pen-up non-interaction with said electrographic surface.

7. The pen apparatus of claim 1 in which said pen orientation detector network comprises:
a solid state input signal treatment network responsive to the assertion or non-assertion thereto of said bias voltage to derive a switching condition; and
a solid state detector switching network responsive to said switching condition to derive a said output at said cable support region corresponding with said pen-down interaction or pen-up non-interaction of said pick-up assembly with said electrographic surface.

8. The pen apparatus of claim 1 in which said pen orientation detector network comprises:
a comparator having one input configured to receive said bias voltage as it extends through a closed said switch assembly and having an opposite input configured to continuously receive a diminished level of said bias voltage and having an output responsive to the presence or absence of said bias voltage at said one input; and
a solid state switch coupled with a circuit voltage source and responsive to said comparator output to derive pen-up or pen-down signals.

9. The pen apparatus of claim 7 in which said pen orientation detector network further comprises:
a delay network responsive to a switching condition corresponding with a pen-down interaction to impose a delay in said response of said detector switching network.

10. The pen apparatus of claim 9 in which:
said delay network is substantially non-responsive to a switching condition corresponding with a pen-up movement of said pick-up rod assembly with respect to said electrographic surface.

11. The pen apparatus of claim 1 in which:
said pickup rod assembly is configured with a collar moveable within said switching cavity, having a rearward surface deriving said travel limiting surface and a forward surface providing a switch function of said switch assembly.

12. The pen apparatus of claim 11 in which:
said switch assembly further comprises a contact surface adjacent said collar forward surface formed of a conformal electrically conductive material.

13. The pen apparatus of claim 1 in which:
said pick-up rod mount assembly mount portion comprises a compression collar and a rearwardly extending spring alignment nub engageable within the forward end of said spring.

14. The pen apparatus of claim 1 in which:
said switch assembly is normally closed under the forward bias of said spring in correspondence with a pen-up non-interaction of said pick-up rod assembly with said electrographic surface.

15. The pen apparatus of claim 1 in which:
said cartridge enclosure is configured with two components each defining one half said switching cavity with one half said stop surface being configured as two oppositely disposed buttressed wall components each having a forwardly disposed stop surface abuttably engageable with said travel limiting surface of said pick-up rod assembly.

16. Pen apparatus for deriving position signals from an electrographic surface, comprising:
an outer housing generally extending along a pen axis from a tip region to a cable support region;
a pick-up rod assembly within said housing slideably disposed along said pen axis, having a tip located at said housing tip region, interactable with said surface having a pen-down orientation when in contacting adjacency with said surface and a pen-up orientation when spaced from said surface, and extending to a pen orientation switching portion with a travel limiting surface and having a mount portion;
a cartridge enclosure mounted within said outer housing extending between said tip region and said cable support region, configured to support said pick-up rod assembly, having a switching cavity configured to receive said switching portion and having a stop surface abuttably engageable with said travel limiting surface to limit the extent of movement of said pick-up rod assembly, said mount portion extending rearwardly of said stop surface;
a spring within said cartridge enclosure having a forward end coupled with said mount portion in forward spring biasing relationship therewith to normally provide said pen-up orientation;
a signal treatment network within said cartridge enclosure having an input electrically coupled with said pick-up rod assembly and having a pen position signal output at said cable support region;
a pen orientation detector network within said cartridge enclosure responsive to a switch input to provide detector outputs corresponding with said pen-down and pen-up orientations; and
a transition contact member configured with a contact portion to define a switch with said pick-up assembly switch portion deriving said switch input.

17. The pen apparatus of claim 16 in which:
said cartridge enclosure is formed of a polycarbornate material.

18. The pen apparatus of claim 16 in which:
said transition contact member contact portion is located forwardly of said pick-up assembly switch portion to define a normally closed switch configuration under the mechanical bias of said spring.

19. The pen apparatus of claim 18 in which:
said normally closed switch configuration corresponds with a pen-up orientation, and said pen-down orientation is derived by moving said pick-up assembly switch portion rearwardly against the mechanical bias of said spring to define an open switch.

20. The pen apparatus of claim 16 in which:
said pick-up assembly switching portion is configured with a contact surface formed of a conformable electrically conductive material

21. The pen apparatus of claim 20 in which:
said electrically conductive material is a carbon-filled silicon polymeric material.

22. The pen apparatus of claim 16 further comprising:
an electrostatic shield within said outer housing configured to effect an electrostatic shielding of said signal treatment and pen orientation networks, said spring, and said switch assembly.

23. The pen apparatus of claim 16 further comprising:
an electrostatic shield mounted within said outer housing, extending over at least that portion of said cartridge enclosure supporting said signal treatment and pen orientation detector networks, said spring, said switch and is configured with a necked-down portion extending from said cartridge enclosure at said tip region to shield a substantial portion of said pick-up rod assembly.

24. The pen apparatus of claim 23 further comprising:
a polymeric, electrically insulative pen tip slideably mounted upon said electrostatic shield at said necked-down portion, engaged with said pick-up rod assembly tip and moveable therewith to define said pen-up and pen-down orientations.

25. The pen apparatus of claim 16 in which:
said pick-up rod assembly switch portion is configured as a collar with a rearward surface serving as said travel limiting surface and with a forward surface corresponding with at least a component of said switching portion.

26. The pen apparatus of claim 25 in which:
said switching portion further comprises a contact surface adjacent said collar forward surface formed of a conformal electrically conductive material.

27. The pen apparatus of claim 16 in which:
said pick-up rod assembly mount portion comprises a compression collar and a rearwardly extending spring alignment nub engageable within said spring forward end.

28. The pen apparatus of claim 16 in which:
said cartridge enclosure is configured with two cartridge components each defining one-half said switching cavity with one-half said stop surface being configured as two oppositely disposed buttressed wall components each having a forwardly disposed stop surface abuttably engageable with said pick-up rod assembly travel limiting surface.

29. Pen apparatus for collecting position signals from an electrographic surface, comprising:
an outer generally cylindrical polymeric outer housing extending along a pen axis from a tip region having a mouth to a cable support region;
a generally cylindrical polymeric cartridge enclosure slideably insertable within said outer housing from said cable support region, having a forward region with a containment cavity with a rearward stop surface, an intermediate region, and a rearward, cable engagement region;
a generally cylindrical electrostatic shield having a sleeve portion slideably insertable over said cartridge enclosure, extending at least over said forward region, containment cavity and intermediate region and configured with a necked-down portion extending from said cartridge enclosure forward region to adjacency with said outer housing mouth;
a pick-up rod assembly having a tip outwardly adjacent said mouth, extending rearwardly through said shield necked-down portion to slideable engagement with said cartridge enclosure forward region and having a switching portion within said containment cavity with a travel limiting surface abuttable with said stop surface to limit the slideable movement of said pick-up assembly and slideably extending through said stop surface to a mount portion;
an elongate printed circuit board mechanically engaged with said cartridge enclosure generally at said intermediate region, having oppositely opposed surfaces extending from a forward edge spaced from said containment cavity to a rearward edge adjacent said cable engagement region;
a signal treatment network mounted upon said circuit board, having an input adjacent said forward edge and an output electrically coupled with a terminal array adjacent said rearward edge;
a pen orientation detector network mounted upon said circuit board, having an input generally adjacent said forward edge and an output electrically coupled with said terminal assembly;
an electrically conductive helical spring fixed to and extending axially forwardly from said circuit board adjacent said forward edge providing electrical communication with said signal treatment network input and in mechanical forward biasing and electrical communication with said pick-up rod assembly mount portion; and
a multi-lead cable assembly mechanically engaged with said cartridge enclosure at said cable engagement region and having leads electrically coupled with said terminal array.

30. The pen apparatus of claim 29 further comprising:
a polymeric, electrically insulative pen tip slideably mounted upon said electrostatic shield at said necked-down portion, extending from said outer housing mouth, abuttably engaged and moveable with said pick-up rod assembly tip.

31. The pen apparatus of claim 30 in which:
said pen tip is configured to align said pick-up assembly as it extends within said electrostatic shield necked-down portion.

32. The pen apparatus of claim 29 in which:
further comprising a transition contact member with a contact portion engageable with said switching portion to define a closed switch condition and having an integrally formed resilient extension abuttably contacting said cartridge enclosure at said intermediate region and resiliently biased into abutting electrical contact with a pad configured input to said pen orientation detector network at a surface of said printed circuit board.

33. The pen apparatus of claim 32 in which:
said transition contact member contact portion is located within said containment cavity forwardly of said pick-up rod switching portion to provide a normally closed switch configuration corresponding with a pen-up orientation of said pick-up rod assembly.

34. The pen apparatus of claim 32 in which:
said pick-up rod assembly switching portion is configured with a contact surface formed of a conformal electrically conductive material located at the forward surface of said travel limiting member.

35. The pen apparatus of claim 29 in which:
said polymeric cartridge enclosure is configured with two identical components each having one or more outwardly depending alignment pins and correspond alignment pin holes and are joined in freely abutting adjacency; and
said printed circuit board is configured with two or more mounting through-holes located to receive said alignment pins.

36. The pen apparatus of claim 29 in which:
said polymeric cartridge enclosure is formed of a polycarbonate material.

37. The pen apparatus of claim 29 in which:
said pick-up rod assembly switching portion is configured as a collar with a rearward surface serving as said travel limiting surface and with a forward surface serving as said switching portion.

38. The pen apparatus of claim 37 in which:
said switching portion further comprises a contact surface adjacent said collar forward surface formed of a conformal electrically conductive material.

39. The pen apparatus of claim 29 in which:
said pick-up rod assembly mount portion comprises a compression collar and a rearwardly extending spring alignment nub engageable within the forward end of said helical spring.

40. The pen apparatus of claim 29 in which:
said polymeric cartridge enclosure is configured with two components each defining one half said containment cavity with one-half said rearward stop surface being configured as two oppositely disposed buttressed wall components each having a forwardly disposed stop surface abuttably engageable with said pick-up assembly travel limiting surface.

41. The method for making a pen apparatus for collecting position signals from an electrographic surface, comprising the steps:
(a) providing a generally cylindrical polymeric outer housing extending, along a pen axis, from a tip region having a mouth, to a cable support region;
(b) providing a pair of generally half cylindrical polymeric cartridge enclosure components which when abuttably mated to define a cartridge enclosure are slideably insertable within said outer housing in symmetrical disposition about said pen axis and define a forward region with a containment cavity, an intermediate region and rearward cable engagement region, said containment cavity having a rearward stop surface with a passage extending therethrough alignable with said pen axis;
(c) providing an elongate circuit board having oppositely disposed surfaces designated upper surface and lower surface extending between a forward end and a rearward end, said upper surface supporting a signal treatment network having an input junction at said forward end locatable at said, pen axis and an output extending to a terminal array adjacent said rearward end, said upper surface further supporting a pen orientation network having an input at an electrical contact pad generally adjacent said forward end at said lower surface locatable at said pen axis and having an output extending to said terminal array;
(d) providing a pick-up rod assembly extending from a tip to a mount portion and having a switching component located forwardly of said mount portion at a location for positioning at said containment cavity;
(e) providing a cable assembly with an array of leads corresponding with said terminal array;
(f) electrically coupling said cable assembly array of leads with said circuit board terminal array;
(g) providing an electrically conductive helical spring;
(h) coupling said helical spring to said circuit board supported signal treatment network input junction at said forward end in a manner wherein the spring extends forwardly for general alignability with said pen axis to a forward connection portion;
(i) coupling said pick-up rod assembly mount portion to said spring forward connection portion in a manner wherein the pick-up rod assembly extends forwardly for general alignability with said pen axis, said pick-up rod assembly, spring, circuit board and cable assembly defining a sub-assembly generally locatable about said pen axis;
(j) providing a transition contact member with a contact portion and an integrally formed resilient extension;
(k) inserting the transition contact member within one cartridge enclosure component in a manner wherein said contact portion is locatable within said containment cavity and said resilient extension is extensible through said stop surface passage to extend rearwardly;
(l) inserting said sub-assembly upon said one cartridge enclosure component;
(m) positioning the other cartridge component over the one cartridge component to define said cartridge enclosure;
(n) providing a generally cylindrical electrostatic shield assembly having a sleeve portion and a forwardly extensible necked-down portion;
(o) inserting the cartridge enclosure within said shield assembly sleeve portion;
(p) providing a polymeric pen tip;
(q) inserting the pen tip over the shield assembly necked-down portion in a manner internally engaging the pick-up rod assembly tip to define a pen interior;
(r) testing the pen interior; and
(s) when the pen interior passes the testing step, then inserting the pen interior into the outer housing.

42. The method of claim 41 in which:
step (b) provides said pair of polymeric cartridge components as being identically configured and formed of a polycarbonate material.

43. The method of claim 41 in which:
step (b) provides a polymeric cartridge component as having at least one shield ground receiving opening located at said intermediate region;
step (c) provides said circuit board as having a resilient downwardly depending shield ground contact at said lower surface and located to be moveable through a said ground receiving opening during step (l); and
step (o) effects the electrical contact of said shield ground contact with the interior of said shield assembly sleeve portion.

44. The method of claim 42 in which:
step (b) provides each cartridge enclosure component intermediate region with two or more integrally formed alignment pins and corresponding oppositely disposed alignment holes;
step (c) provides the circuit board as having four or more alignment through-holes located for engagement with said alignment pins; and
step (l) effects the engagement of said through-holes with said alignment pins.

45. The method of claim 44 in which:
step (m) effects the insertion of said alignment pins into said alignment holes subsequent to step (l).

46. The method of claim 41 in which:
step (l) effects the positioning of said pick-up rod assembly switching component within the containment cavity portion of said one cartridge component in a manner wherein the switching component is located in spring biased engagement with the transition contact member.

47. The method of claim 41 in which:
step (l) effects the circuit completing abutment of the resilient extension of the transition contact member with the electrical contact pad at the circuit board lower surface.

48. An electrographic system, comprising:
an electrographic surface switchable with a coordinate defining sequence of a.c. voltage waveforms exhibiting excitation peak-to-peak amplitudes.
pen apparatus having an outer housing hand graspable by a user, a pick-up rod assembly within the outer housing having a tip contactable with said surface to collect pen position coordinate signals, and a signal treatment network including an operational amplifier enabled by connection with system ground and circuit supply power, responsive to said pen position coordinate signals to provide a pen position output to a cable having a shield at system ground when the system is in a pen mode and at an a.c. shield signal condition emulating said a.c. waveforms to provide a zero coupling capacitance differential upon contact of said cable with said surface when said system is in a touch mode, and a filter configured to filter the ground input to circuit supply power to isolate the operational amplifier from said a.c. shield signal condition; and
a control system coupled with said electrographic surface and said cable, providing said electrographic excitation, said system ground, circuit supply power, deriving said touch mode applying said a.c. shield signal condition to said cable shield while responding to coordinate defining conditions at said electrographic surface, and during said pen mode applying system ground to said cable shield and responding to said pen position output.

49. The system of claim 48 in which:
said pen apparatus filter is an R.C. filter and charge reservoir supporting the operation of said operational amplifier.
